(19) United States
(12) Patent Application Publication
(10) Pub. No.: US 2008/0169997 A1
(43) Pub. Date: Jul. 17, 2008

(54) Multi-dimensional image selectable display device

(76) Inventor: Kyung-ho Choi, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/007,886

(22) Filed: Jan. 16, 2008

(30) Foreign Application Priority Data
Jan. 16, 2007 (KR) 10-2007-0004808

(51) Int. Cl. G09G 5/00

(52) U.S. Cl. 345/6

(57) ABSTRACT

A multi-dimensional image selectable display device, including an image panel adapted to output images and a barrier panel on an upper portion of the image panel so as to display the images as a two-dimensional (2D) image or a three-dimensional (3D) image. The barrier panel may include a first substrate having a first electrode and a second electrode to generate a horizontal electric field between the first and second electrodes, a second substrate having a transparent electrode on a front surface thereof, and a liquid crystal layer between the first and second substrates. The liquid crystal layer may include liquid crystals. The first and second electrodes may include a plurality of pattern units, wherein each of the pattern units may include a plurality of fine patterns extending therefrom.

### BACKGROUND OF THE INVENTION

1. Field of the Invention

Example embodiments relate to a display device and, more particularly, to a multi-dimensional image selectable display device.

2. Description of the Related Art

Three-dimensional (3D) images for expressing 3D information may be achieved via a stereo visual principle based on binocular parallax. Generally, human eyes are spaced, e.g., approximately 65 mm, apart from each other. Thus, the left eye may view one two-dimensional (2D) image, and the right eye may view another 2D image. The two 2D images may then be transferred via the eye and processed by a brain to reproduce depth and perception of 3D images. In order to display 3D images, various methods, e.g., a special spectacle display method, a non-spectacle display method and a holographic display method, may be employed to display the images.

The special spectacle display method may be categorized as a polarized spectacle method, a time division spectacle method or a concentration difference method. The polarized spectacle method may use vibrating direction or rotating direction of a polarized light. The time division spectacle method may provide left and right images in an alternate manner. The concentration difference method may transfer lights of different brightness to the respective left and right eyes.

The non-spectacle display method may be categorized as a parallax method, a lenticular method or an integral photography method. The parallax method may cause a viewer to divide and observe the images through a longitudinal lattice shaped aperture in front of respective images corresponding to the left and right eyes. The lenticular method may use a lenticular plate. The integral photography method may use a fly's eye lens sheet.

The holographic display method may be categorized as a laser beam play hologram method and a white light play hologram method. The holographic display method may obtain 3D images with various factors, e.g., focus adjustment, convergence angle, binocular parallax and motion parallax, to provide 3D perception.

Each of the above methods, however, may have drawbacks and disadvantages. For example, in the special spectacle display method, viewers must wear polarized spectacles or liquid crystal shutter spectacles to view 3D images, resulting in inconvenience and uncomfortableness to the viewers. In the non-spectacle display method, due to the observed range being narrowly fixed, only a small number of viewers may view 3D images because the viewer must directly look into the display to view the 3D images, i.e., the angle of view is very narrow. In the holographic display method, this method may be restrictive due to difficulty in operating equipments, i.e., utilizing 3D coordinates on a space through a laser, lens and a mirror, and limited space requirements, i.e., large space occupied by the equipments.

### SUMMARY OF THE INVENTION

Example embodiments are therefore related to a multi-dimensional image selectable display device and methods thereof, which substantially overcome one or more of the problems due to the limitations and disadvantages of the related art.

It is therefore a feature of example embodiments to provide a multi-dimensional image selectable display device capable of converting and switching between 2D images and 3D images.

Another feature of example embodiments is to provide a multi-dimensional image selectable display device capable of switching between a wide angle viewing mode and a narrow angle viewing mode during display of 2D images.

Another feature of example embodiments is to provide a multi-dimensional image selectable display device including a barrier panel having a first electrode and a second electrode to generate a horizontal electric field between the first and second electrodes, so as to selectively display 2D or 3D images.

At least one of the above and other features of example embodiments may be realized by providing a multi-dimensional image selectable display device, including an image panel adapted to output images and a barrier panel on an upper portion of the image panel so as to display the images as a 2D image or a 3D image. The barrier panel may include a first substrate having a first electrode and a second electrode to generate a horizontal electric field between the first and second electrodes, a second substrate having a transparent electrode on a front surface thereof, and a liquid crystal layer between the first and second substrates. The liquid crystal layer may include liquid crystals. The first and second electrodes may include a plurality of pattern units, each of the pattern units may include a plurality of fine patterns extending therefrom.

The first substrate may include first regions functioning as barriers and second regions functioning as slits. The second regions may function as the slits when a voltage is applied to the first electrode and second electrodes to create the horizontal electric field. The first regions and the second regions may be arranged at predetermined intervals. One of the first regions may include one pattern unit of the first electrode and one pattern unit of the second electrode adjacent to each other. The fine patterns extending from each of the pattern units of the first and second electrodes may be alternately arranged. One of the second regions may include a pair of pattern units of the first electrode. The fine patterns extending from each of the pair of pattern units may be alternately arranged.

The multi-dimensional image selectable display device may further include a first alignment layer and a second alignment layer. The first and second alignment layers may be formed at inner side surfaces of the first and second substrates, respectively. The first and second alignment layers may be rubbed in anti-parallel manner to align the liquid crystals in an initial electrical controlled birefringence (ECB) mode.

The barrier panel may selectively display the 2D or 3D images according to whether the horizontal predetermined electric field is applied to the first and second electrodes of the first substrate. The barrier panel may display the 2D images in a wide viewing angle or a narrow viewing angle according to whether a vertical electric field is applied to electrodes of the first and second substrates. The 2D images in the narrow viewing angle may be displayed when the vertical electric field is applied to the electrodes of the first and second substrates. The 3D images may be displayed when a vertical electric field is not applied between the first and second substrates, and the horizontal electric field is applied between the first and second electrodes of the first substrate.

The image panel selectively outputs 2D images or 3D images. The image panel may be embodied in at least one of a liquid crystal display (LCD) device, a plasma display panel (PDP) device, and an organic light emitting diode (OLED) display device.

### BRIEF DESCRIPTION OF THE DRAWINGS

The above and other features and advantages of example embodiments will become more apparent to those of ordinary skill in the art by describing in detail example embodiments thereof with reference to the attached drawings, in which:

FIG. 1 illustrates a schematic cross-sectional view of a display device according to an example embodiment;

FIG. 2 illustrates a schematic cross-sectional view of an exemplary barrier panel of FIG. 1;

FIG. 3 illustrates a schematic plan view of exemplary first electrodes and second electrodes formed on the barrier panel of FIG. 2; and

FIGS. 4A to 4C illustrate schematic perspective views of operating the display device according to example embodiments.

### DETAILED DESCRIPTION OF THE INVENTION

Korean Patent Application No. 10-2007-0004808, filed on Jan. 16, 2007, in the Korean Intellectual Property Office, and entitled: “2D and 3D Image Selectable Display Device,” is incorporated by reference herein in its entirety.

Example embodiments will now be described more fully hereinafter with reference to the accompanying drawings. The invention may, however, be embodied in different forms and should not be construed as limited to the embodiments set forth herein. Rather, these example embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, the expression “predetermined electric field” is used to refer to a horizontal electric field or a vertical electric field.

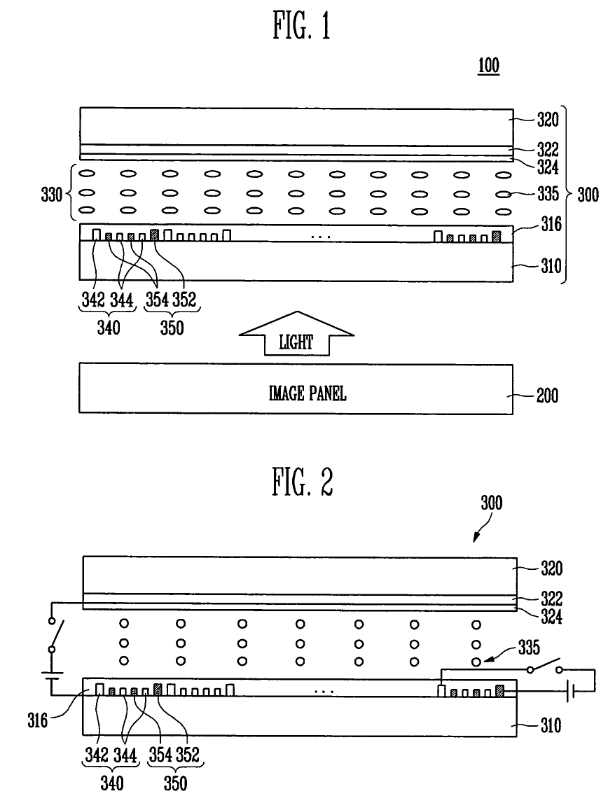

Referring to FIG. 1, a display device 100 may include an image panel 200 and a barrier panel 300. The image panel 200 may be embodied on liquid crystal displays (LCDs), plasma display panels (PDPs), organic light emitting diode (OLED) display devices and the like.

The barrier panel 300 may include a first substrate 310, a second substrate 320, and a liquid crystal layer 330 having liquid crystals 335 therein. The liquid crystal layer 330 may be formed between the first and second substrates 310 and 320. The liquid crystals 335 may be aligned in an initial electrically controlled birefringence (ECB) mode. The first substrate 310 may include a first electrode 340 and a second electrode 350 arranged therein to form a predetermined electric field, i.e., a horizontal electric field. The first and second electrodes 340 and 350 may be an In-Plane-Switching (IPS) type electrode.

A transparent electrode 322 may be formed on a front surface of the second substrate 320 to provide a 2D/3D conversion. The transparent electrode 322 may be operated in a wide angle viewing mode or a narrow angle viewing mode during the display of 2D images.

A first orientation layer 316 and a second orientation layer 324 may further be formed on inner sides of each of the first and second substrates 310 and 320, respectively. The first and second alignment layers 316 and 324 may be anti-parallel rubbed to initially align the liquid crystals 335 into the initial ECB mode.

The barrier panel 300 may be disposed between the image panel 200 and an observer, so that the barrier panel 300 may transmit and/or block light generated in the image panel 200. The image panel 200 may selectively display 2D images or 3D images. When a 2D image is displayed, the barrier panel 300 may directly transmit the image output from the image panel 200. When a 3D image is displayed, however, the observer may view a virtual 3D image through slits and barriers of the barrier panel 300. The slits and barriers may respectively pass and block light output from the image panel 200, and may be alternately arranged. In addition, the observer may observe images displayed on the image panel 200 through the slits of the barrier panel 300. In particular, the left eye and right eye of the observer may observe different regions of the image panel 200 through the same slit. In other words, the left eye and right eye may view images corresponding to pixels of different regions through the slits, so as to perceive the 3D image, i.e., the left eye may view a corresponding left pixel on the image panel 200 and the right eye may view a corresponding right pixel on the image panel 200.

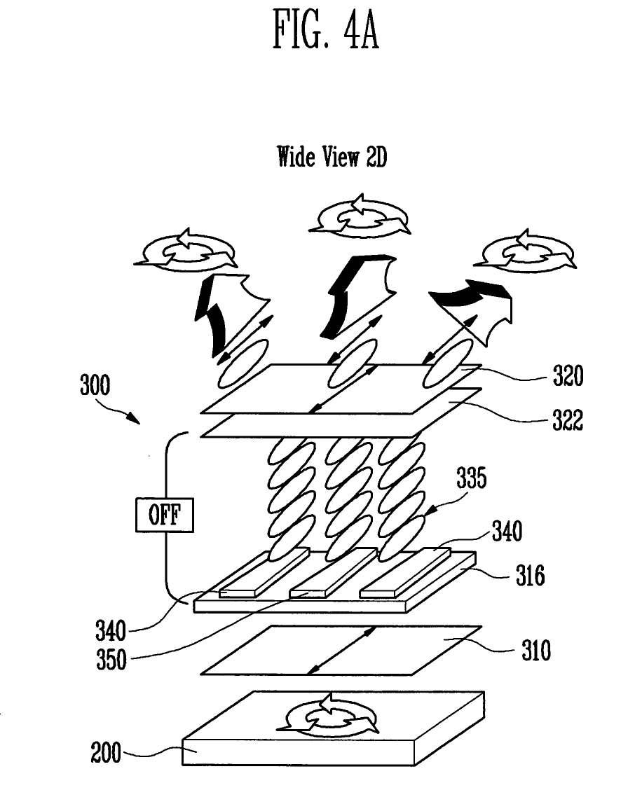

Referring to both FIGS. 1 and 3, the first electrode 340 and the second electrode 350 may each include a plurality of pattern units 342 and 352, respectively. Each of the pattern units 342 and 352 may be constructed so that a plurality of patterns 341 and 351 may be extending thereof; In addition, a plurality of fine patterns 344 and 354 may be formed extending from each of the patterns 341 and 351, respectively. The plurality of fine patterns 344 and 354 may extend in a direction perpendicular to the patterns 341 and 351. Other configurations besides the one described above may be employed to form the first electrode 340 and the second electrode 350.

The first substrate 310 may be divided into a plurality of first regions 420 and a plurality of second regions 440 at a predetermined distance from each other. The first regions 420 may function as the barriers and the second regions 440 may function as the slits.

The first region 420 may be defined as a region where adjacent pattern units 342 and 352 of respective first and second electrodes 340 and 350 are arranged, and having fine pattern 344 and 354 alternately arranged. The first electrode 340 in the first region 420 may have one electric potential, and the second electrode 350 in the first region 420 may have another electric potential. Accordingly, because the predetermined electric field, i.e., the horizontal electric field, in the first region 420 is formed by applying different electric potentials to the first electrode 340 and the second electrode 350, the liquid crystals 335 located above the first region 420 may be oriented in such a manner that light does not transmit. Thus, the first region 420 may function as the barrier.

The second region 440 may be defined as a region where a pair of pattern units 342 of the first electrode 340 are arranged, and having fine pattern 344 alternately arranged. Each of first electrodes 340 in the second region 440 may have the same electric potential due to having the same power source. Accordingly, because the predetermined electric field, i.e., the horizontal electric field, in the second region 440 is formed by applying the same electric potential, i.e., a zero potential difference, to each of the first electrode 340, the liquid crystals 335 located above the second region 440 may be oriented in such a manner that light does transmit. Thus, the second region 440 may function as the slit.

Methods embodied by the display device 100 will now be described in detail. When 2D images are to be displayed, the barrier panel 300 may operate in one of two modes. One mode may be operated when there is no predetermined electric field, i.e., a vertical electric field, formed between the electrodes included in the first and second substrates 310 and 320 of the barrier panel 300. During this mode, the liquid crystals 335 in the liquid crystal layer 330 may be arranged to correspond to a transmission axis of a polarizing plate (not shown). The polarizing plate may be included on the image panel 200 so as to provide a wide angle viewing capability of the 2D images. Another mode may be operated when there is a predetermined electric field, i.e., a vertical electric field, formed between the electrodes included in the first and second substrates 310 and 320 of the barrier panel 300. During this mode, the liquid crystals 335 in the liquid crystal layer 330 may be oriented toward a vertical direction so that an angle of plane angle of the liquid crystals 335 may be inclined at approximately 45° with respect to the transmission axis of the polarizing plate. The barrier panel 300 may, therefore, have a front surface of white characteristics and a side surface of black characteristics. Accordingly, the side surfaces of the barrier panel 300 may display black due to the inclined liquid crystals 335.

When 3D images are to be displayed, the barrier panel 300 may enable the observer to view a virtual 3D stereoscopic image through the slits and barriers by respectively transmitting and blocking light from the right-eye pixel and the left-eye pixel of the image panel 200.

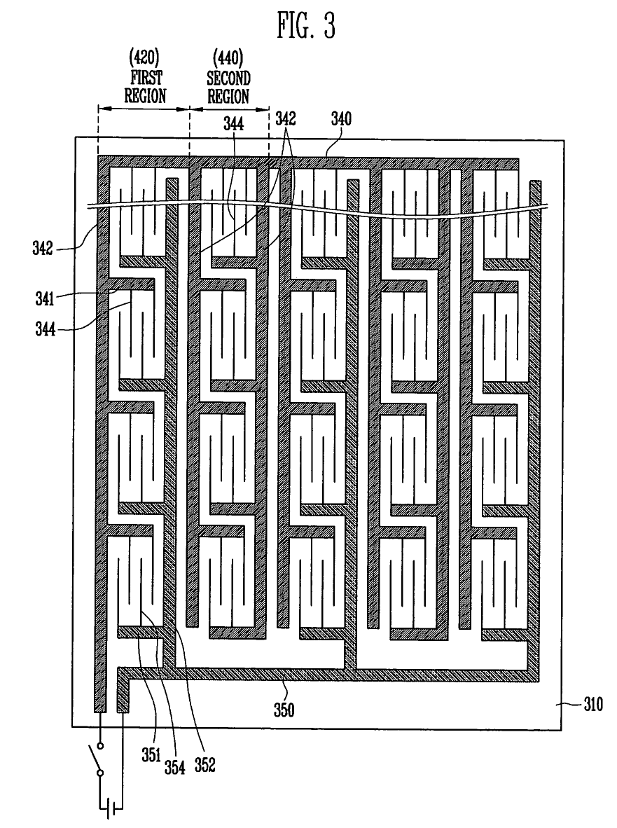

Referring to FIG. 2, the barrier panel 300 may include the first substrate 310 having the first electrode 340 and the second electrode 350 to generate the predetermined electric field, i.e., the horizontal electric field. The barrier panel 300 may further selectively display 2D/3D images according to whether or not a potential electric difference is applied between the first and second electrodes 340 and 350, i.e., whether a horizontal electric field is formed in predetermined regions of the first substrate 310.

When no predetermined electric field, i.e., a horizontal electric field, is applied between the pair of pattern units 342 of the first electrodes 340 (due to having the same electric potential), the liquid crystals 335 in the liquid crystal layer 330 may be oriented in such a manner that light may directly pass through the liquid crystal layer 330 and, thus, functioning as slits of the barrier panel 300. In addition, since the pair of pattern units 342 of the first electrodes 340 has the same electric potential, there may be a reduction in total resistance of the electrodes formed on the first substrate 310.

When a predetermined electric field, i.e., a horizontal electric field, is applied between the pattern units 342 and 352 of the first and second electrodes 340 and 350, the liquid crystals 335 in the liquid crystal layer 330 may be oriented in such a manner that light may not pass through the liquid crystal layer 330, i.e., may be blocked, and, thus, functioning as barriers of the barrier panel 300.

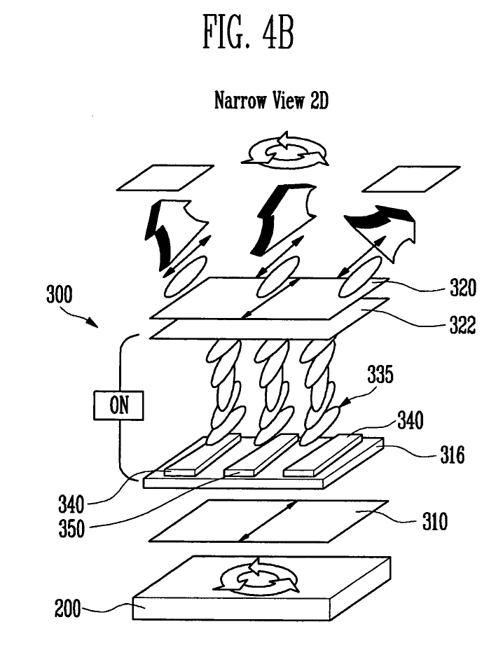

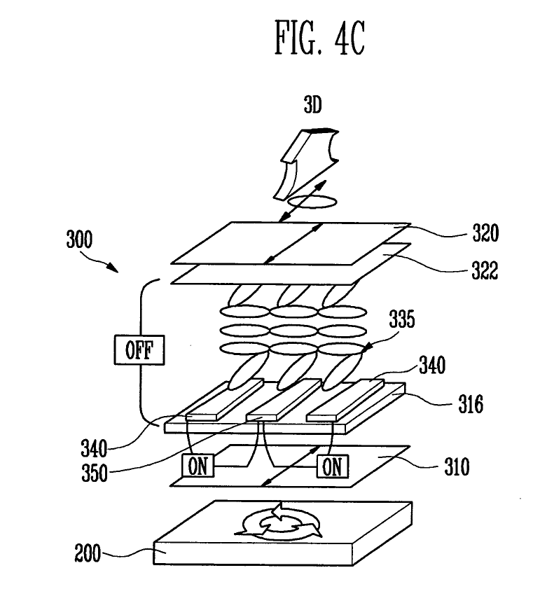

Referring to FIG. 4A, during a 2D wide angle viewing mode, the predetermined voltage, i.e., the vertical electric field, may not be applied between the first and second substrates 310 and 320 of the barrier panel 300. In addition, the predetermined voltage, i.e., the horizontal electric field, may also not be applied between the first and second electrodes 340 and 350 formed on the first substrate 310. Accordingly, since the liquid crystal layer 330 inside the barrier panel 300 is not subject to any predetermined electric fields, the liquid crystal layer 330 may be maintained in an initial orientation state. As such, the liquid crystal layer 330 formed in the barrier panel 300 may be arranged corresponding to the transmission axis of the polarizing plate included on the image panel 200 to enable 2D wide angle viewing.

Referring to FIG. 4B, during a 2D narrow viewing angle mode, the predetermined voltage, e.g., the vertical electric field, may be applied between the first and second substrates 310 and 320 of the barrier panel 300. In addition, the predetermined voltage, e.g., the horizontal electric field, may not be applied between the first and second electrodes 340 and 350 formed on the first substrate 310. Accordingly, since the predetermined voltage, e.g., the vertical electric field, is applied to the first and second substrates 310 and 320, the liquid crystals 335 in the liquid crystal layer 330 may be vertically oriented at a predetermined angle, so that an angle of plane angle of the liquid crystals 335 may be approximately 45° with respect to the transmission axis of the polarizing plate included on the image panel 200. As a result, the front surface of the barrier panel 300 may maintain white characteristics so that the observer may view an image, and the side surfaces of the barrier panel 300 may appear black so that no images may be viewed by the observer at the sides of the barrier panel 300 and, thus, provide a 2D narrow viewing angle.

Referring to FIG. 4C, during a 3D display mode, the predetermined voltage, i.e., the vertical electric field, may not be applied between the first and second substrates 310 and 320 of the barrier panel 300. In addition, the predetermined voltage, e.g., the horizontal electric field, may be applied between the first and second electrodes 340 and 350 formed on the first substrate 310. Accordingly, the predetermined electric field, i.e., the horizontal electric field, may orient the liquid crystals 335 in the liquid crystal layer 330 in such a manner to transmit and/or block light generated in the image panel 200. In other words, when no predetermined electric field, i.e., a horizontal electric field, is applied between the pair of pattern units 342 of the first electrodes 340 (due to having the same electric potential), the liquid crystals 335 in the liquid crystal layer 330 may be oriented in such a manner that light may directly pass through the liquid crystal layer 330 and, thus, functioning as slits of the barrier panel 300. Further, when the predetermined electric field, i.e., the horizontal electric field, is applied between the pattern units 342 and 352 of the first and second electrodes 340 and 350, the liquid crystals 335 in the liquid crystal layer 330 may be oriented in such a manner that light may not pass through the liquid crystal layer 330 and, thus, functioning as barriers of the barrier panel 300. As such, this arrangement may provide the same constitution as one obtained by alternatively forming slits and barriers in a vertical manner.

Example embodiments may include a barrier panel 300 applying a potential electric difference to electrodes of an IPS type included on the first substrate 310, so as to selectively implement 2D/3D images according to whether the predetermined electric field is formed over a specific region.

Example embodiments may provide the user to selectively display a 2D wide angle viewing mode or a 2D narrow viewing angle mode. In addition, the user may also selectively change the display from a 2D display mode to a 3D display mode.

Example embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A multi-dimensional image selectable display device, comprising:
an image panel adapted to output images; and
a barrier panel on an upper portion of the image panel so as to display the images as a two-dimensional (2D) image or a three-dimensional (3D) image, the barrier panel including:
a first substrate having a first electrode and a second electrode to generate a horizontal electric field between the first and second electrodes, the first and second electrodes including a plurality of pattern units, each of the pattern units having a plurality of fine patterns extending therefrom,
a second substrate having a transparent electrode on a front surface thereof, and
a liquid crystal layer between the first and second substrates, the liquid crystal layer having liquid crystals.

2. The multi-dimensional image selectable display device as claimed in claim 1, wherein the first substrate comprises first regions functioning as barriers and second regions functioning as slits.

3. The multi-dimensional image selectable display device as claimed in claim 2, wherein the second regions function as the slits when a voltage is applied to the first electrode and second electrodes to create the horizontal electric field.

4. The multi-dimensional image selectable display device as claimed in claim 2, wherein the first regions and the second regions are arranged at predetermined intervals.

5. The multi-dimensional image selectable display device as claimed in claim 2, wherein one of the first regions comprises one pattern unit of the first electrode and one pattern unit of the second electrode adjacent to each other.

6. The multi-dimensional image selectable display device as claimed in claim 5, wherein the fine patterns extending from each of the pattern units of the first and second electrodes are alternately arranged.

7. The multi-dimensional image selectable display device as claimed in claim 2, wherein one of the second regions comprises a pair of pattern units of the first electrode.

8. The multi-dimensional image selectable display device as claimed in claim 7, wherein the fine patterns extending from each of the pair of pattern units are alternately arranged.

9. The multi-dimensional image selectable display device as claimed in claim 1, further comprising a first alignment layer and a second alignment layer, the first and second alignment layers being formed at inner side surfaces of the first and second substrates, respectively.

10. The multi-dimensional image selectable display device as claimed in claim 9, wherein the first and second alignment layers are rubbed in anti-parallel manner to align the liquid crystals in an initial electrical controlled birefringence (ECB) mode.

11. The multi-dimensional image selectable display device as claimed in claim 1, wherein the image panel selectively outputs 2D images or 3D images.

12. The multi-dimensional image selectable display device as claimed in claim 1, wherein the barrier panel selectively displays the 2D or 3D images according to whether the horizontal predetermined electric field is applied to the first and second electrodes of the first substrate.

13. The multi-dimensional image selectable display device as claimed in claim 12, wherein the barrier panel displays the 2D images in a wide angle viewing or a narrow viewing angle according to whether a vertical electric field is applied to electrodes of the first and second substrates.

14. The multi-dimensional image selectable display device as claimed in claim 13, wherein the 2D images in the narrow viewing angle are displayed when the vertical electric field is applied to the electrodes of the first and second substrates.

15. The multi-dimensional image selectable display device as claimed in claim 12, wherein the 3D images are displayed when a vertical electric field is not applied between the first and second substrates, and the horizontal electric field is applied between the first and second electrodes of the first substrate.

16. The multi-dimensional image selectable display device as claimed in claim 1, wherein the image panel is embodied in at least one of a liquid crystal display (LCD), a plasma display panel (PDP) and an organic light emitting diode (OLED) display device.
